(19) United States
(12) Patent Application Publication
(10) Pub. No.: US 2021/0298474 A1
(43) Pub. Date: Sep. 30, 2021

(54) Waterproof and Fire-resistant Storage Device

(71) Applicant: Charmaine Brewer, Oklahoma City, OK (US)

(72) Inventor: Charmaine Brewer, Oklahoma City, OK (US)

(21) Appl. No.: 17/216,851

(22) Filed: Mar. 30, 2021

Related U.S. Application Data
(60) Provisional application No. 63/001,764, filed on Mar. 30, 2020.

(51) Int. Cl. A47B 88/963; E05B 65/46; A62C 2/06

(52) U.S. Cl. CPC A47B 88/963; E05B 65/46; A47B 2210/06; A47B 2210/01; A62C 2/06

(57) ABSTRACT

A waterproof and fire-resistant storage container is shown and described. The waterproof and fire-resistant storage device is made up of a housing. The housing will generally include a base and a plurality of sidewalls. The housing will have an open side that has a gasket surrounding the perimeter of the open side. The opening will accept either a drawer a door or a lid. When the opening is closed the gasket will form a waterproof seal. The interior of the housing is lined with a fire-resistant material. Further, the waterproof and fire-resistant storage device will have a veneer placed around the exterior of the device.

### CROSS REFERENCE TO RELATED APPLICATIONS

This application claims the benefit of U.S. Provisional Application No. 63/001,764 filed on Mar. 30, 2020. The above identified patent application is herein incorporated by reference in its entirety to provide continuity of disclosure.

### BACKGROUND OF THE INVENTION

The present invention relates to a waterproof and fire-resistant storage device. More particularly, the present invention provides a storage device that will protect valuable and delicate items from common destructive forces such as floods and fires.

Many individuals have valuable items and sensitive documents that they store in their homes. These items often need additional protection. In some cases, these items will be destroyed by fires or moisture. It can be extremely difficult to get new documents if obtaining such copies is even possible.

Currently storage systems that protect documents and other valuable Stems are not waterproof. Additionally, it can be difficult to find storage devices that are appealing in proper sizes. Often larger devices are not aesthetically pleasing. This means that an individual may have to purchase many small unsightly devices. Even then the storage devices do not protect frorn moisture.

Consequently, there is a need for an improvement in the art of storage and protection. The present invention substantially diverges in design elements from the known art while at the same time solves a problem many people face when storing sensitive items in a safe manner while still having a aesthetically pleasing storage device. In this regard the present invention substantially fulfills these needs.

### SUMMARY OF THE INVENTION

The present invention provides a waterproof and fire-resistant storage device wherein the same can be utilized for providing convenience for the user when using a waterproof and fire-resistant storage device. The waterproof and fire-resistant storage device is comprised of a housing having a top section, a bottom section, a rear section, and a plurality of sidewalls. The housing has an open front and an interior volume. The open front is adapted to accept a drawer therein. A gasket is placed around the perimeter of the open front wherein the gasket will create a waterproof seal with the drawer. A fire-resistant liner is placed around the interior volume of the housing.

Another object of the waterproof and fire-resistant storage device is to provide a housing that is adapted to accept multiple drawers therein.

Another object of the waterproof and fire-resistant storage device is to provide a housing that has a veneer covering the exterior to provide and aesthetic appeal.

Another object of the waterproof and fire-resistant storage device is to provide a drawing with a locking device that will secure the drawer in a closed position when closed and locked.

Another object of the waterproof and fire-resistant storage device is to provide a handle located on the front of the drawer to open and close the drawer.

Another object of the waterproof and fire-resistant storage device is to provide a fire-resistant liner will protect the interior contents of the device from fire for 30 minutes.

Another object of the waterproof and fire-resistant storage device is to provide a housing having a top section, a bottom section, a rear section, and a plurality of sidewalk. The housing has an open front, wherein the open front is adapted to accept a door thereon.

Another object of the waterproof and fire-resistant storage device is to provide a looking device will keep the door in a secured closed position.

Another object of the waterproof and fire-resistant storage device is to provide a handle located on the front of the door.

Another object of the waterproof and fire-resistant storage device is to provide a housing made frorn metal.

Another object of the waterproof and fire-resistant storage device is to provide a housing having a bottom section and a plurality if sidewalk rising from the bottom section. The housing has an open top and an interior volume. The open top is adapted to accept a door thereon.

Another object of the waterproof and fire-resistant storage device is to provide a veneer that looks like an old trunk having a leather cover and closing straps.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the waterproof and fire-resistant storage device.

FIG. 2 shows a perspective view of an embodiment of the waterproof and fire-resistant storage device as a filing cabinet.

FIG. 3 shows a perspective view of an embodiment of the waterproof and fire-resistant storage device as a standing cabinet.

FIG. 4 shows a perspective view of an embodiment of the waterproof and fire-resistant storage device as a trunk.

FIG. 5 shows a perspective view of an embodiment of the waterproof and fire-resistant storage device with a wooden veneer.

### DETAILED DESCRIPTION OF THE INVENTION

Reference is made herein to the attached drawings. Like reference numerals are used throughout the drawings to depict like or similar elements of the waterproof and fire-resistant storage device. For the purposes of presenting a brief and clear description of the present invention, a preferred embodiment will be discussed as used for the waterproof and fire-resistant storage device. The figures are intended for representative purposes only and should not be considered to be limiting in any respect.

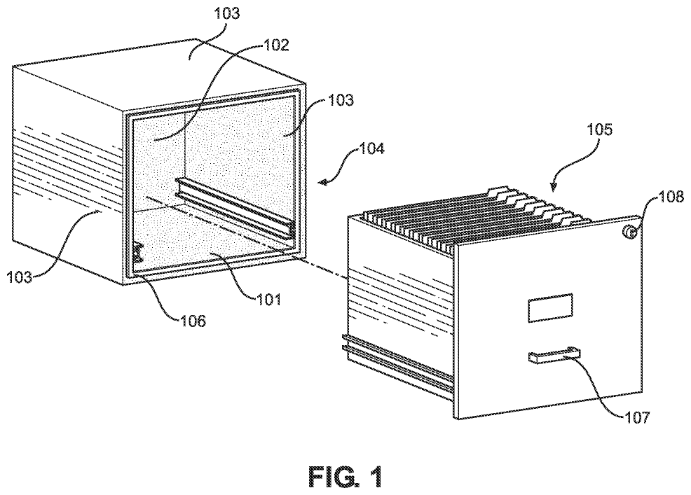

Referring now to FIG. 1, there is shown a perspective view of an embodiment of the waterproof and fire-resistant storage device. In one embodiment waterproof and fire-resistant storage device is comprised of a base 101, a rear section 102 and a plurality of sidewalk 103.

The base 101 is the section that will rest on the bottom of the device. The rear section 102 will rise from the base 101 having the sidewalk 103 rise from the base 101 and cover the top of the storage device opposite the base 101. This will create an interior volume of the storage device. The front of the storage device is open.

The interior volume of the storage device is lined with a fire-resistant material 104. The fire-resistant material 104 will keep items safe within the storage device for at least 30 minutes in a fire condition. The fire-resistant material 104 will line the entire interior to ensure fire cannot penetrate the storage device.

In this embodiment the open front of the storage device is adapted to fit a drawer 105 therein. The drawer 105 will fit within the interior volume of the storage device. In one embodiment the drawer 105 is a filing cabinet drawer. This will allow for storage of files. The front of the drawer 105 has a fire-resistant material 104 located thereon. When the drawer 105 is closed the fire-resistant material 104 will create a full covering for the storage device. This will create a full fire-resistant coating along the interior volume of the storage device.

In one embodiment, the drawer 105 has a handle 107 secured to an exterior side. The handle 107 will allow a user to move the drawer 105 from the closed to the open position. In another embodiment, the drawer 105 further has a locking device 108. The locking device 108 will keep the drawer 105 secured in a closed position when engaged. In one embodiment the locking device 108 is a key lock. In another embodiment the locking device is a combination lock.

The opening of the storage device has a gasket 106 around the perimeter. The gasket 106 will engage with the drawer 105 when in a closed position. The gasket 106 will create a waterproof seal about pening. When the drawer 105 is in the closed position the interiorof the volume of the storage device will be waterproof protecting the contents inside of the storage device.

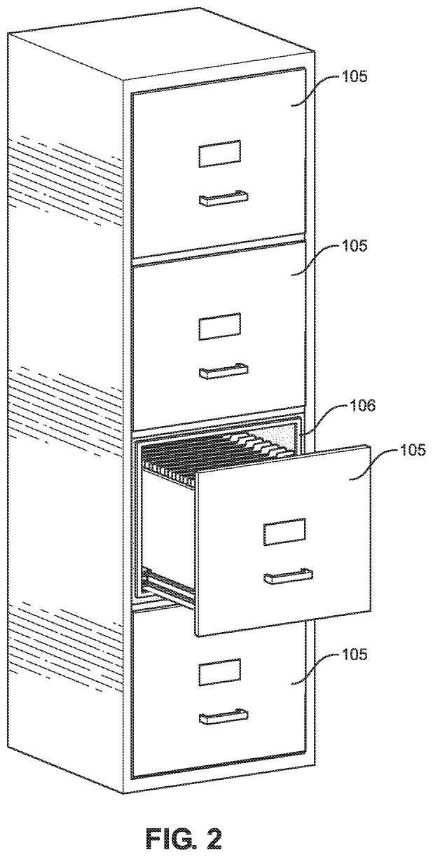

Referring now to FIG. 2, there is shown a perspective view of an embodiment of the waterproof and fire-resistant storage device as a filing cabinet. In the shown embodiment waterproof and fire-resistant storage device is converted into a filing cabinet. In one embodiment multiple storage devices as described in FIG. 1 are stacked together to create a filing cabinet. This will allow the device to have multiple filing drawers 105. Each of the drawers 105 will have their own waterproof and fire-resistant compartment as described in FIG. 1.

In another embodiment, the waterproof and fire-resistant storage filing cabinet has a single interior volume. The entire interior volume is coated with a fire-resistant material. In this embodiment the front of the filing cabinet has a plurality of openings therein. The plurality of openings is each configured to accept a drawer 105 therein. Each opening has a gasket 106 around the perimeter. The gasket 106 will create a waterproof seal when the drawer 105 is in the closed position. This will create a waterproof and fire-resistant interior volume for the filing cabinet.

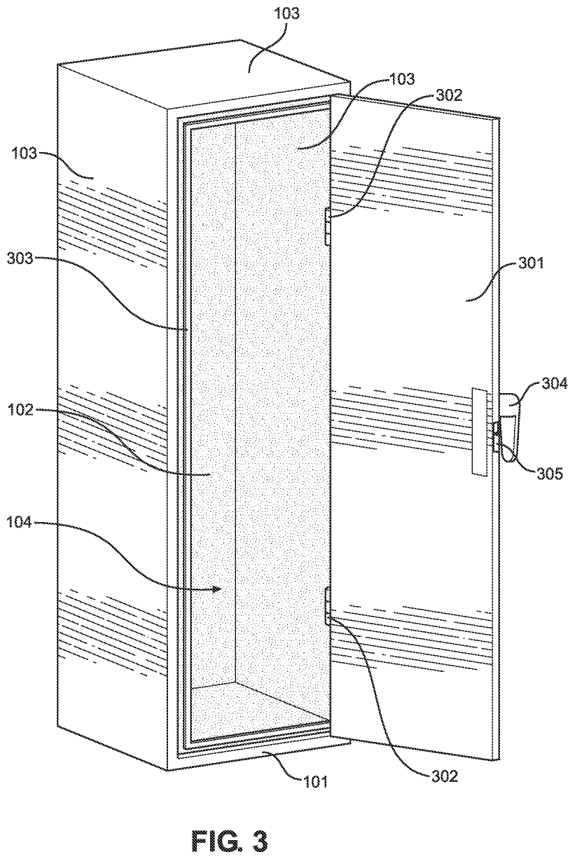

Referring now to FIG. 3, there is shown a perspective view of an embodiment of the waterproof and fire-resistant storage device as a standing cabinet. In one embodiment the storage device is creating using a standing cabinet. The standing cabinet has a base 101, a rear section 102 and a plurality of sidewalls 103.

The base 101 is the section that will rest on the bottom of the device. The rear section 102 will rise from the base 101 having the sidewalk 103 rise from the base 101 and cover the top of the storage device opposite the base 101. This will create an interior volume of the storage device. The front of the storage device is open.

The interior volume of the storage device is lined with a fire-resistant material 104, The fire-resistant material 104 will keep items safe within the storage device for at least 30 minutes in a fire condition. The fire-resistant material 104 will line the entire interior to ensure fire cannot penetrate the storage device.

The front of the storage device is configured to accept a door 301 thereon. In one embodiment the door 301 is secured to the to the storage device via a plurality of hinges 302. The interior of the door 301 is covering in the fire-resistant material 104. When the door is in a closed position the interior volume of the storage device will be fire-resistant.

In one embodiment, the door 301 has a handle 304. The handle 304 will allow the door 301 to be opened and closed. In one embodiment the door handle will allow the door to he secured in a closed position. In one embodiment the door 301 has a locking device 305. In one embodiment the locking device 305 is integrated into the handle 301, In another embodiment the locking device 305 is a separate device. In one embodiment, the locking device 305 is a key lock. In another embodiment, the locking device 305 is a combination lock.

The open front of the storage device has a gasket 303 located around the perimeter of the opening. The gasket 303 will engage the interior of the door 301 when in a closed position. The gasket 303 will create a waterproof seal such that the internal volume of the storage device is waterproof.

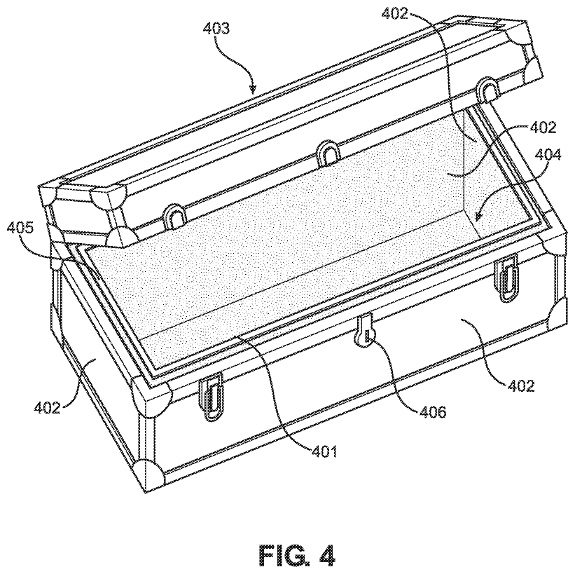

Referring now to FIG. 4, there is shown a perspective view of an embodiment of the waterproof and fire-resistant storage device as a trunk. The trunk embodiment of the waterproof and fire-resistant storage device includes a base 401. The base 401 has a plurality of sidewalls 402 rising vertically therefrom. This will create and interior volume. The sidewalls 402 further create an open top end. A lid 403 engages withthe top end of the sidewalls 402.

The interior volume of the truck embodiment of the waterproof and fire-resistant storage device has a fire-resistant material 404 located around the entire interior volume. The fire-resistant material 404 will protect the interior of the device from fire. In one embodiment the first resistant material 404 will withstand at least 30 minutes of fire.

The top perimeter of the sidewalk 402 has a gasket 405 located therearound. The gasket 405 will engage with the lid 403 of the trunk embodiment of the storage device. When the lid 403 is in the closed configured the gasket 405 will create a waterproof seal with the interior volume of the trunk. This will create a waterproof and fire-resistant storage device.

In some embodiments, the exterior of the trunk has items added for function and aesthetic appeal. In one embodiment, the exterior of the trunk is designed to look like an old style trunk. In this embodiment the trunk has a leather covering. In other embodiments, the trunk may have other exterior decor to look like an old trunk. In one embodiment, the exterior decor may include a locking system 406. The locking system 406 will engage such that a pad lock can hold the trunk in a closed position. In other embodiments, other locking systems 406 may be used.

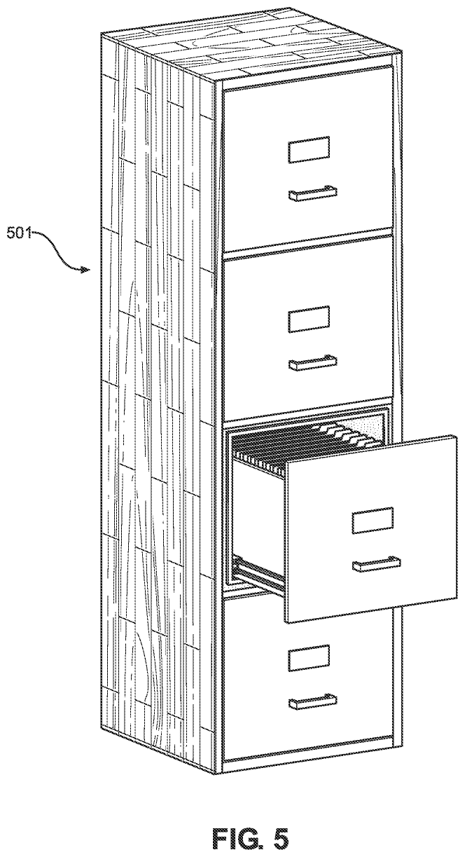

Referring now to FIG. 5, there is shown a perspective view of an embodiment of the waterproof and fire-resistant storage device with a wooden veneer. In different embodiments the storage device is covered with different coverings. In one embodiment the storage device is built into a piece of furniture. These coverings or adapted furniture will give the device an aesthetic appeal. This will better allow individuals to protect their valuables.

In one embodiment, the covering is a paint. In another embodiment, the covering is a powder coated material. In the shown embodiment, the covering is a wooden veneer 501. This will allow the device to have a wooden look. This will hide the true nature of the device. Further, a wooden veneer will allow the device to be stained to match existing furniture.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A waterproof and fire-resistant storage device, comprising:
a housing having a top section, a bottom section, a rear section, and a plurality of sidewalls;
the housing defining an open front opposite the rear section and an interior volume defined within the housing;
the open front adapted to accept a drawer therein;
a gasket is placed around the perimeter of the open front wherein the gasket will create a waterproof seal with the drawer;
a fire-resistant liner is placed around the interior volume of the housing.

2) The waterproof and fire-resistant storage device of claim 1, further comprising the housing is adapted to accept multiple drawers therein.

3) The waterproof and fire-resistant storage device of claim 1, further comprising a veneer placed on the exterior of the housing.

4) The waterproof and fire-resistant storage device of claim 1, wherein the drawer has a locking device will keep the drawer in a secured position.

5) The waterproof and fire-resistant storage device of claim 1, further comprising a handle located on the front of the drawer.

6) The waterproof and fire-resistant storage device of claim 1, wherein the fire-resistant liner will protect the interior contents of the device from fire for 30 minutes.

7) The waterproof and fire-resistant storage device of claim 1, wherein the housing is made of metal.

8) The waterproof and fire-resistant storage device of claim 1, wherein the housing comprises a leather cover.

9) The waterproof and fire-resistant storage device of claim 1, further comprising a plurality of closing straps.
